(19) United States
(12) Patent Application Publication
(10) Pub. No.: US 2023/0334874 A1
(43) Pub. Date: Oct. 19, 2023

(54) IDENTIFYING VEHICLE BLINKER STATES

(71) Applicant: GM Cruise Holdings LLC, SAN FRANCISCO, CA (US)

(72) Inventors: Yi Zhang, San Francisco, CA (US); Xingxing Huang, Los Gatos, CA (US); Gia Tri Nguyen, Kirkland, WA (US)

(21) Appl. No.: 17/722,127

(22) Filed: Apr. 15, 2022

(51) Int. Cl. G06V 20/58; G06V 10/60; G06V 10/82; G06V 10/774; G06V 10/22

(52) U.S. Cl. CPC G06V 20/584; G06V 10/60; G06V 10/82; G06V 10/7747; G06V 10/22; G06V 2201/10; B60R 11/04

(57) ABSTRACT

The disclosed technology provides solutions for improving perception systems and in particular for improving perception systems of autonomous vehicles (AVs). A process of the disclosed technology can provide solutions for improving vehicle blinker detection/identification. In some approaches, blinker detection/identification can include steps for receiving a set of image frames, identifying image areas in the set of image frames, corresponding with a light source of the vehicle, and determining a blinker state associated with the vehicle. Systems and machine-readable media are also provided.

### BACKGROUND

### 1. Technical Field

The disclosed technology provides solutions for improving autonomous vehicle (AV) perception and in particular, for improving the identification of vehicle blinker states so that vehicle behaviors can be more accurately predicted.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning, and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 conceptually illustrates an example blinker detection scenario, according to some aspects of the disclosed technology.

FIG. 2 illustrates an example of a machine-learning model that can be used to detect (or predict) vehicle blinker states, according to some aspects of the disclosed technology.

FIG. 3 illustrates a flow diagram of an example process for implementing a vehicle blinker identification approach, according to some aspects of the disclosed technology.

FIG. 4 illustrates an example system environment that can be used to facilitate AV dispatch and operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Perception systems of autonomous vehicles (AVs) are designed to detect various objects in the surrounding environment in order to execute effective navigation and planning operations. To ensure safety, such systems are designed to detect and identify behaviors of various entities in the surrounding environment, including those of traffic participants, such as other vehicles. One useful cue for inferring near-term future behaviors of other vehicles is to take consideration of vehicle blinker states. For example, activated left-blinker lights are likely to be correlated with left-turn maneuvers, whereas activated brake lights are likely to be correlate with braking maneuvers, etc. However, conventional AV perception systems, which utilize rule-based or heuristic approaches to determine blinker states, often fail to correctly detect/classify the correct blinker status of less frequent traffic participants or rare traffic participants. By way of example, rule-based heuristic approaches do not perform well when presented with detection scenarios that include uncommon light placements, such as those often found on exotic vehicles, or of light placements for large or special-purpose vehicles, such as fire trucks, or garbage trucks, etc.

Aspects of the disclosed technology address the foregoing limitations by providing novel blinker state detection approaches. In some aspects, the disclosed technology includes solutions that utilize a multi-layered machine learning approach, whereby vehicle light locations are first identified, for example, using a machine-learning (ML) model, e.g., an attentional layer. Once light locations have been correctly identified, then blinker states can be determined, for example, using additional machine-learning models, e.g., a blinker state prediction layer. In some aspects, the attentional layer and the blinker state prediction layer may be implemented as different layers of a common machine-learning model. In other aspects, the attentional layer and the blinker state prediction layer may be implemented as separate or discrete machine-learning models. Although some of the disclosed examples relate to the detection of blinker states using sensor data collected from camera sensors, such as signal cameras and/or red-green-blue (RGB) imaging devices, it is understood that other types of image acquisition data may be used, without departing from the scope of the disclosed technology.

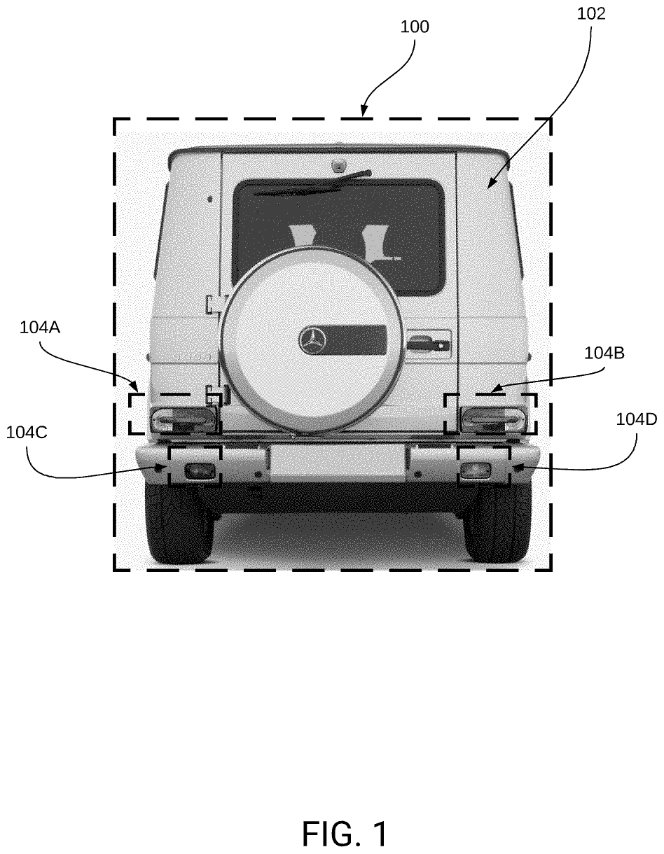

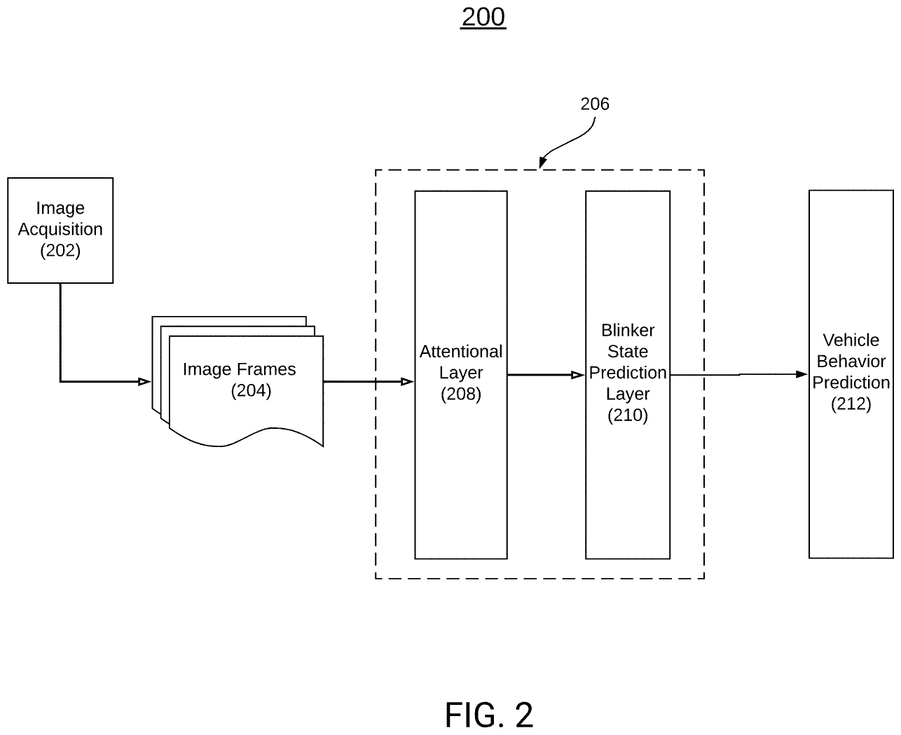

FIG. 1 conceptually illustrates an example blinker detection scenario, according to some aspects of the disclosed technology. In particular, FIG. 1 illustrates an example of a single image frame 100, that includes a vehicle 102. In some approaches, image frame 100 can represent a single frame of sensor data (e.g., image data) collected from an optical sensing device, such as a camera. However, in operation, it is understood that detection/identification of blinker states can be performed using two or more frames, as discussed in further detail with respect to FIG. 2, below. Additionally, depending on the desired implementation, one or more different types of cameras can be used to acquire the sensor/image data. For example, image frame 100 can represent camera data collected from a red-green-blue (RGB) camera, image/sensor data collected from a signal camera, and/or image/sensor data representing a composite of image data collected from various sources and/or camera types. A signal camera has a shorter exposure time than a conventional camera. Thus, the signal camera is able to capture only strong light (e.g., blinker and brake lights) without capturing weak light sources (e.g., unilluminated portions of a vehicle).

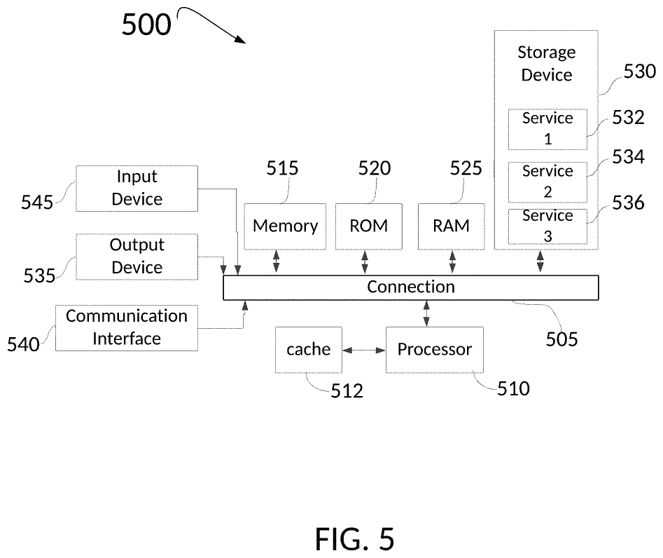

In operation, a vehicle signal identification solution of the disclosed technology can be used to identify vehicle blinker states for the vehicle 102. The identified/determined blinker states can be used by an AV, for example, to facilitate predictions or inferences about the behavior of vehicle 102. As discussed in further detail with respect to FIG. 5, behavioral predictions about vehicles (e.g., about vehicle 102) in an environment surrounding an AV may be made using an AV perception system to better reason about the environment, and to improve navigation and routing decisions.

In some approaches, determinations about a blinker state of vehicle 102 can be made using one or more machine-learning (ML) models. For example, ML approaches may be used to first identify regions of interest within image frame 100, for example, that correspond with image regions (pixel areas) that are predicted to contain lights, such as blinkers, of the vehicle 102. The identification of regions of interest can be performed using an ML model that has been trained to predict the pixel regions of blinkers across one or more image frames. As depicted in the example of FIG. 1, lights of vehicle 102 are identified in the image areas corresponding with bounding boxes 104A, 104B, 104C, and 104D (collectively bounding boxes 104).

Once the locations of the vehicle lights have been determined (e.g., using a first ML model, such as an attentional model), the identified interest regions can be used to facilitate the determination of on/off states of various blinkers. In some aspects, a second machine-learning model can be utilized to make determinations (predictions) about the blinker state of one or more vehicle lights identified by the first ML model. As discussed in further detail below with respect to FIG. 2, such determinations can be made using multiple frames. By using multiple successive/subsequent image frames, the temporal nature of blinker states can be captured in the frame set and used to identify an associated on/off state of the corresponding blinker.

Although FIG. 1 illustrates an example vehicle 102 with four total identified lights, it is understood that a greater (or fewer) number of lights may be identified, in the same (or different) locations, without departing from the scope of the disclosed technology. By first identifying the regions of interest in image frame 100 (e.g., the image areas containing vehicle lights), a machine-learning based detection system can make more efficient and accurate predictions, for example, by avoiding classification analysis on image areas that do not contain blinkers. For example, the model may not incorrectly correlate a turning vehicle and its left blinker on. Rather, the model may be limited to only identifying a state of a vehicle blinker (e.g., on or off). A more detailed description of how machine-learning approaches can be used to perform blinker detection and/or to identify blinker states, is provided with respect to FIG. 2, below.

In particular, FIG. 2 illustrates an example blinker detection/identification system 200 that can be used to detect (or predict) vehicle blinker states. System 200 includes the receipt or acquisition of sensor data that includes one or more vehicles (block 202). In some aspects, image acquisition can be performed using one or more sensor devices, such as one or more cameras. Depending on the desired implementation, various camera types may be used. For example, one or more signal cameras and/or red-green-blue (RGB) cameras may be used to acquire sensor (image) data that includes sensor data representing one or more vehicles. The acquired sensor data can include one or more images or image frames 204, for example, that represent sensor data collected by various AV sensors about an environment proximate to or around the AV. Image frames 204 can include image recordings (e.g., video recordings) of various traffic participants (vehicles) in operation in a driving scenario, such as driving on a freeway, or street, etc.

Image frames 204 can then be provided to a blinker identification/detection system 206. Depending on the desired implementation, blinker detection system 206 may be, or may include one or more machine-learning models and/or ML network layers. As illustrated in the example of FIG. 2, image frames 204 can be first provided to attentional layer 208, which identifies image (pixel) regions that are associated with portions of an image object (vehicle) that are likely to contain lights, such as vehicle blinkers. Similar to the example discussed above with respect to FIG. 1, attentional layer 208 can identify regions of an image (e.g., image frame 100) that include vehicle lights, such as image areas indicated by bounding boxes 104. As discussed above, the identification of blinkers can be performed across multiple image frames, such as successive frames representing changing blinker states of a vehicle. By first identifying image areas likely to contain an object of interest (e.g., vehicle blinkers), the attentional layer 208 can reduce the amount of sensor (image data) provided to blinker state prediction layer 210. The blinker identification/detection system 206 can be generalized to identify a blinker state for rare traffic participants having lights (e.g., blinker and brake lights) in unconventional locations and/or in unconventional configurations (e.g., C-shaped blinker).

The attentional layer 208 can include a machine-learning model, (e.g., an ML neural-network) that has been trained to detect/identify vehicle blinkers. For example, attentional layer 208 can represent layers of a machine-learning model that has been trained using labeled training data, e.g., in which vehicle blinkers have been identified (e.g., by a labeler using bounding boxes) for the purpose of ML model training.

The blinker state prediction layer 210 can be configured to process various regions of interest (e.g., as indicated by attentional layer 208), across multiple image frames 204, to determine (classify) a blinker state of the corresponding vehicle. By way of example, blinker state prediction layer 210 may make blinker state classifications on a per-vehicle basis. The classifications can be one or more of a predetermined set of classification categories, including but not limited to one or more of: a left-turn signal light, a right-turn signal light, a reverse signal light, and/or a brake light, etc. Similar to the training process described above with respect to attentional layer 208, the prediction layer 210 can be (or can include) a machine-learning model that has been trained using training data that includes successive image frames for which blinker states have been pre-identified, e.g., by a human labeler.

Once the blinker state of a target vehicle has been identified, the detected blinker state may be provided to one or more perception layers, e.g., of an AV perception stack. By way of example, the detected blinker state may be used, e.g., by the AV perception stack, to make determinations about current vehicle behaviors/maneuvers, or likely future behaviors/maneuvers. By way of example, the blinker state may be used by the AV to better reason about various maneuvers of other traffic participants, including, left/right turns, u-turns, stopping, emergency braking, and/or lane changes, etc. In some aspects, detected light/blinker state may be used to identify current (or future) operations/behaviors of special purpose vehicles, such as first responders, e.g., ambulance/s, fire truck/s, and/or law enforcement vehicles, etc.

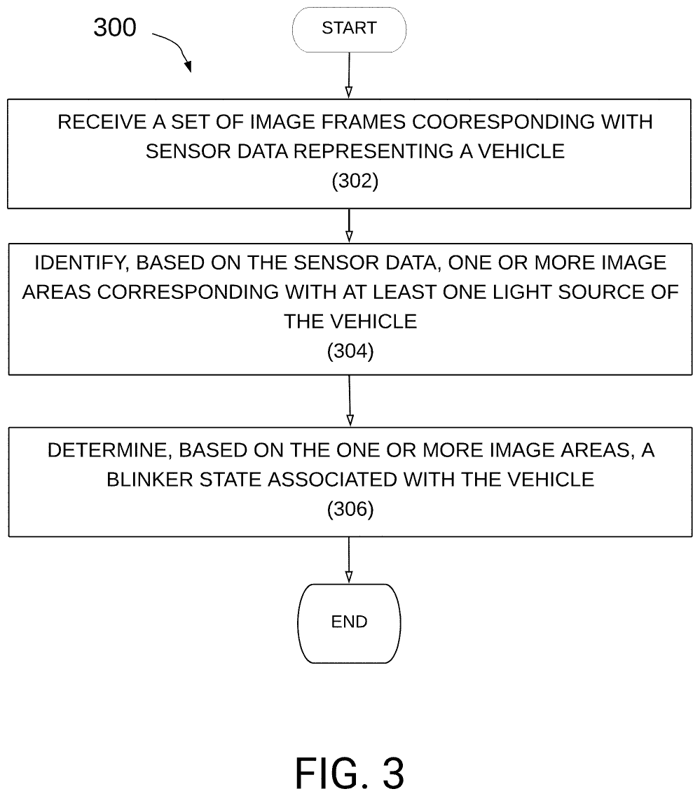

FIG. 3 illustrates a flow diagram of an example process 300 for implementing a vehicle blinker identification approach, according to some aspects of the disclosed technology. Process 300 beings with step 302 in which a set of image frames are received (e.g., by a blinker detection system, as discussed with respect to FIG. 2, above). The image frames can correspond with sensor data representing a vehicle (or multiple vehicles). By way of example, the image frames may be included in sensor data collected by one or more AV sensors, such as one or more signal cameras and/or RGB cameras operated as part of an AV sensor stack. As such, the image fames can represent one or more traffic participants (vehicles) that were encountered by an AV, and stored as bag data, for example, in a database that includes AV sensor data recorded by one or more AVs during the course of operation.

At step 304, process 300 includes identifying, based on the sensor data, one or more image areas in the image frames, corresponding with at least one light source of the vehicle. As discussed above, identification of image areas corresponding with vehicle light sources (e.g., blinkers, brake lights, and/or turn signals, etc.) can be accomplished using a machine-learning approach. As discussed with respect to the example of FIG. 3, an attentional network or network layer (e.g., attentional layer 208), can be used to identify image regions likely to include vehicle lights/blinkers. In some aspects, these regions of interest may be indicated by bounding boxes that are added to (or associated with) the image frames, e.g., as bounding box metadata. By identifying image areas of interest, the total amount of sensor/image data used to determine a blinker state associated with the vehicle (step 306), can be greatly reduced. Blinker state identifications/classifications can include detections of left/right-turn signals, braking lights, reverse lights, or other vehicle operation modes. By way of example, the identification/detection system may classify operations or behaviors (e.g., using a prediction network or network layer) of various vehicle types, including less frequently encountered vehicles, such as light patterns associated with emergency vehicles, first responders, law enforcement, construction vehicles/equipment, garbage trucks, and/or dump-trucks etc. As such, blinker state determinations can be used to understand a current behavior and/or predict a future behavior of the associated vehicle. By way of example, an AV perceptions system can use the determined blinker state to make inferences about likely behaviors of the associated vehicle, including but not limited to inferences about vehicle maneuvers, such as turning, stopping, and/or accelerating etc.

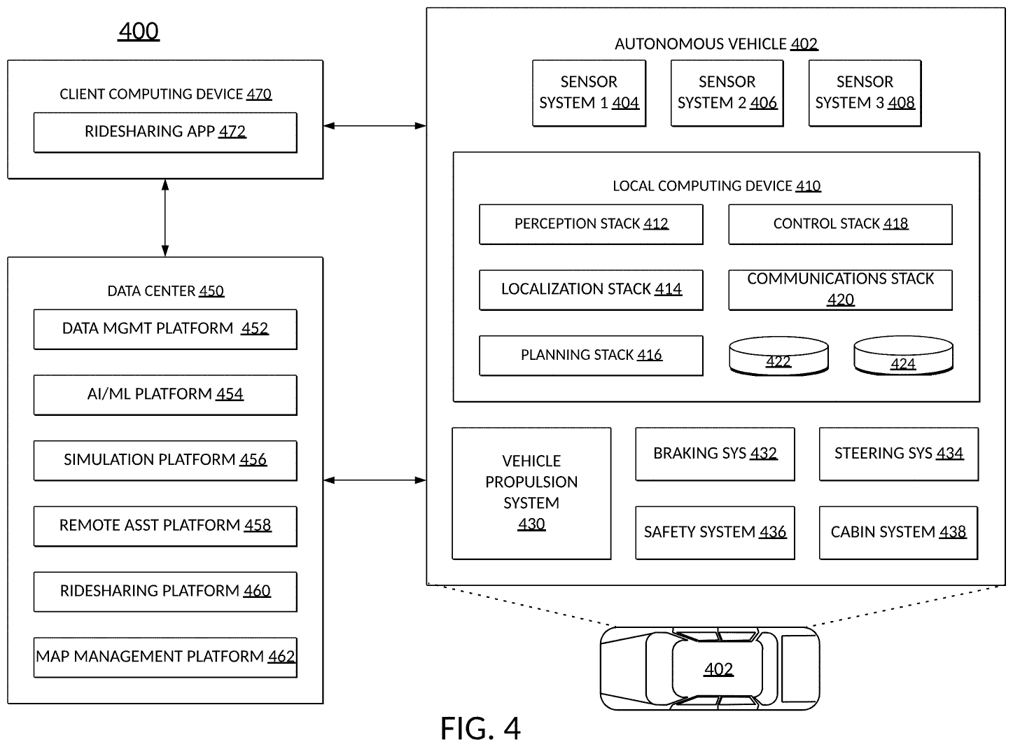

Turning now to FIG. 4 illustrates an example of an AV management system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate about roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

AV 402 can also include several mechanical systems that can be used to maneuver or operate AV 402. For instance, the mechanical systems can include vehicle propulsion system 430, braking system 432, steering system 434, safety system 436, and cabin system 438, among other systems. Vehicle propulsion system 430 can include an electric motor, an internal combustion engine, or both. The braking system 432 can include an engine brake, brake pads, actuators, and/or any other suitable componentry configured to assist in decelerating AV 402. The steering system 434 can include suitable componentry configured to control the direction of movement of the AV 402 during navigation. Safety system 436 can include lights and signal indicators, a parking brake, airbags, and so forth. The cabin system 438 can include cabin temperature control systems, in-cabin entertainment systems, and so forth. In some embodiments, the AV 402 may not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces, e.g., Graphical User Interfaces (GUIs), Voice User Interfaces (VUIs), etc., for controlling certain aspects of the mechanical systems 430-438.

AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a planning stack 416, a control stack 418, a communications stack 420, an HD geospatial database 422, and an AV operational database 424, among other stacks and systems.

Perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 422, other components of the AV, and other data sources (e.g., the data center 450, the client computing device 470, third-party data sources, etc.). The perception stack 412 can detect and classify objects and determine their current and predicted locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth.

In some aspects, the perception stack 412 can be configured to perform operations necessary for identifying blinker state information for one or more traffic participants. As such, perception stack can be configured to perform one or more of the operations of FIG. 3, discussed above.

Mapping and localization stack 414 can determine the AV's position and orientation (pose) using different methods from multiple systems (e.g., GPS, IMUs, cameras, LIDAR, RADAR, ultrasonic sensors, the HD geospatial database 422, etc.). For example, in some embodiments, the AV 402 can compare sensor data captured in real-time by the sensor systems 404-408 to data in the HD geospatial database 422 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The planning stack 416 can determine how to maneuver or operate the AV 402 safely and efficiently in its environment. For example, the planning stack 416 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another. The planning stack 416 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 416 can select from multiple backup plans to carry out. For example, while preparing to change lanes to turn right at an intersection, another vehicle may aggressively cut into the destination lane, making the lane change unsafe. The planning stack 416 could have already determined an alternative plan for such an event, and upon its occurrence, help to direct the AV 402 to go around the block instead of blocking a current lane while waiting for an opening to change lanes.

The control stack 418 can manage the operation of the vehicle propulsion system 430, the braking system 432, the steering system 434, the safety system 436, and the cabin system 438. The control stack 418 can receive sensor signals from the sensor systems 404-408 as well as communicate with other stacks or components of the local computing device 410 or a remote system (e.g., the data center 450) to effectuate operation of the AV 402. For example, the control stack 418 can implement the final path or actions from the multiple paths or actions provided by the planning stack 416. This can involve turning the routes and decisions from the planning stack 416 into commands for the actuators that control the AV's steering, throttle, brake, and drive unit.

The communication stack 420 can transmit and receive signals between the various stacks and other components of the AV 402 and between the AV 402, the data center 450, the client computing device 470, and other remote systems. The communication stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 420 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 422 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408 and other components of the AV 402 and/or data received by the AV 402 from remote systems (e.g., the data center 450, the client computing device 470, etc.). In some embodiments, the raw AV data can include HD LIDAR point cloud data, image data, RADAR data, GPS data, and other sensor data that the data center 450 can use for creating or updating AV geospatial data as discussed further below with respect to FIG. 2 and elsewhere in the present disclosure.

The data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, a ridesharing platform 460, and map management system platform 462, among other systems.

Data management platform 452 can be a “big data” system capable of receiving and transmitting data at high velocities (e.g., near real-time or real-time), processing a large variety of data, and storing large volumes of data (e.g., terabytes, petabytes, or more of data). The varieties of data can include data having different structure (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management system platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management system platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from the map management system platform 462; modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smart watch, smart eyeglasses or other Head-Mounted Display (HMD), smart ear pods or other smart in-ear, on-ear, or over-ear device, etc.), gaming system, or other general purpose computing device for accessing the ridesharing application 472. The client computing device 470 can be a customer's mobile computing device or a computing device integrated with the AV 402 (e.g., the local computing device 410). The ridesharing platform 460 can receive requests to be picked up or dropped off from the ridesharing application 472 and dispatch the AV 402 for the trip.

Map management system platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, UAVs, satellites, third-party mapping services, and other sources of geospatially referenced data. The raw data can be processed, and map management system platform 462 can render base representations (e.g., tiles (2D), bounding volumes (3D), etc.) of the AV geospatial data to enable users to view, query, label, edit, and otherwise interact with the data. Map management system platform 462 can manage workflows and tasks for operating on the AV geospatial data. Map management system platform 462 can control access to the AV geospatial data, including granting or limiting access to the AV geospatial data based on user-based, role-based, group-based, task-based, and other attribute-based access control mechanisms. Map management system platform 462 can provide version control for the AV geospatial data, such as to track specific changes that (human or machine) map editors have made to the data and to revert changes when necessary. Map management system platform 462 can administer release management of the AV geospatial data, including distributing suitable iterations of the data to different users, computing devices, AVs, and other consumers of HD maps. Map management system platform 462 can provide analytics regarding the AV geospatial data and related data, such as to generate insights relating to the throughput and quality of mapping tasks.

In some embodiments, the map viewing services of map management system platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client application 472 to enable passengers to view the AV 402 in transit en route to a pick-up or drop-off location, and so on.

FIG. 5 illustrates an example processor-based system with which some aspects of the subject technology can be implemented. For example, processor-based system 500 can be any computing device making up internal computing system 510, remote computing system 550, a passenger device executing the rideshare app 570, internal computing device 530, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. An apparatus for identifying vehicle blinker states, comprising:
at least one memory; and
at least one processor coupled to the at least one memory, the at least one processor configured to:
receive a set of image frames, wherein the set of image frames correspond with sensor data representing a vehicle;
identify, based on the sensor data, one or more image areas, in the set of image frames, corresponding with at least one light source of the vehicle; and
determine, based on the one or more image areas, a blinker state associated with the vehicle.

2. The apparatus of claim 1, wherein the at least one processor is further configured to:
predict a behavior of the vehicle based on the blinker state associated with the vehicle.

3. The apparatus of claim 1, wherein to determine the blinker state associated with the vehicle, the set of image frames is provided to a machine-learning neural network.

4. The apparatus of claim 3, wherein the machine-learning neural network comprises an attentional layer.

5. The apparatus of claim 3, wherein the machine-learning neural network comprises a prediction layer.

6. The apparatus of claim 1, wherein the set of image frames are collected by a signal camera, a red-green-blue camera, or a combination thereof.

7. The apparatus of claim 1, wherein the apparatus is a perception system of an autonomous vehicle (AV).

8. A computer-implemented method for identifying vehicle blinker states comprising:
receiving a set of image frames, wherein the set of image frames correspond with sensor data representing a vehicle;
identifying, based on the sensor data, one or more image areas, in the set of image frames, corresponding with at least one light source of the vehicle; and
determining, based on the one or more image areas, a blinker state associated with the vehicle.

9. The computer-implemented method of claim 8, further comprising:
predicting a behavior of the vehicle based on the blinker state associated with the vehicle.

10. The computer-implemented method of claim 8, wherein to determine the blinker state associated with the vehicle, the set of image frames is provided to a machine-learning neural network.

11. The computer-implemented method of claim 10, wherein the machine-learning neural network comprises an attentional layer.

12. The computer-implemented method of claim 10, wherein the machine-learning neural network comprises a prediction layer.

13. The computer-implemented method of claim 8, wherein the set of image frames are collected by a signal camera, a red-green-blue camera, or a combination thereof.

14. The computer-implemented method of claim 8, wherein the set of image frames is received from one or more cameras mounted on an autonomous vehicle (AV).

15. A computer-implemented method for training a blinker detection system, comprising:
receiving a first set of training data, wherein the first set of training data comprises a first plurality of labeled image frames;
training a first machine-learning model using the first set of training data;
receiving a second set of training data, wherein the second set of training data comprises a second plurality of labeled image frames; and
training a second machine-learning model using the second set of training data.

16. The computer-implemented method of claim 15, wherein one or more of the first plurality of labeled image frames comprises one or more bounding boxes indicating a pixel location of an associated vehicle blinker.

17. The computer-implemented method of claim 15, wherein one or more of the second plurality of labeled image frames is associated with metadata identifying a corresponding blinker state.

18. The computer-implemented method of claim 15, wherein the first machine-learning model is configured to identify pixel regions associated with vehicle blinkers.

19. The computer-implemented method of claim 15, wherein the second machine-learning model is configured to identify blinker states.

20. The computer-implemented method of claim 15, wherein the first plurality of labeled image frames comprises: red-green-blue (RGB) camera image data, signal camera image data, or a combination thereof.
